(19) United States
(12) Patent Application Publication
(10) Pub. No.: US 2005/0083632 A1
(43) Pub. Date: Apr. 21, 2005

(54) Container discharge system with groundig device

(76) Inventor: Hans-Ulrich Hahn, Neustadt (DE)

Correspondence Address: Scott Jacobson;Honeywell International Inc, 101 Columbia Road, Morristown, NJ, 07962, US

(21) Appl. No.: 10/496,921

(22) PCT Filed: Nov. 26, 2002
(86) PCT No.: PCT/EP02/13308

(30) Foreign Application Priority Data
Nov. 30, 2001 (DE) 101588178

(51) Int. Cl. H05F 3/00

(52) U.S. Cl. 361/215

(57) ABSTRACT

Discharge system for filling and emptying containers, in particular drum-like transporting containers, in particular for the uptake of inflammable liquids, wherein the discharge system comprises a grounding wire by means of which electric charges are discharged from a liquid being uptaken in the container to a grounding potential.

The invention relates to a discharge system for filling and emptying of containers, in particular of barrel-like transport drums, which can be inserted exchangeable into a container opening which can receive a plug head.

Such a discharge system is known from WO 98/49090. This discharge system serves for filling and emptying containers. It can be inserted into a container opening, receiving a plug head, so as to be exchangeable. The discharge system comprises a riser tube being connected with the plug head and a removal connection element. A conduit can be connected to the removal connection element for a transfer of the chemicals. Furthermore, a ventilation of the container via a ventilation means also being arranged in the removal connection element is provided.

The discharge system is designed in a way that a mixing up of chemicals can be avoided. For this purpose the discharge system is provided with a removal connection element which may be locked by means of coding studs and corresponding coding recesses with the plug head. The coding studs are arranged on a first securing part and the coding recesses on a second securing part. One of the securing parts is formed as an annular disc which can separately be fitted loosely such that it cannot slip off onto the modular removal connection element.

However, the storage and the transport of inflammable liquids or chemicals requires particular attention. By discharge of electrostatic charges in the container an ignition of an inflammable liquid stored in the container may be provoked. This danger particularly exists during the discharge of the liquid or chemical, respectively. Therefore, common transport drums made of plastics for storage and for transport of inflammable liquids or chemicals have been restricted to a small volume of a maximum of five liters by legal regulations.

In order to reduce the risk of ignitions, smaller containers of one sheet of conductive plastics are used for inflammable chemicals. Suitable plastics highly filled with carbon, however, only comprise little mechanical stability and are unsuitable for large containers having a volume up to 10.000 liters.

An alternative with respect to containers made of one sheet of conductive plastics are metal containers. They comprise the stability necessary for large containers and may easily be grounded by means of a wire in order to discharge electrostatic charging. However, they are rather expensive in production, particularly, if determined for transport and for storage of highly pure chemicals, the use of containers made of special steel being necessary for those. Due to their high cost of production, metal containers are principally suited for multiple use and are not very economic for long distance deliveries, e.g. to overseas destinations as the metal container has to be sent back after its discharge.

By the use of multiple sheet extrusion technique the inexpensive production of stable larger containers has become possible. However, the problem further remains that those are unsuitable for inflammable liquids due to the risk an ignition by electrostatic charges or strokes, particularly during the discharge of containers.

Thus, it is an object of the present invention to provide a discharge system for containers, particularly for inflammable liquids, reducing or preventing, respectively, the risk of ignitions of the contents of the container, particularly during the discharge.

This object is achieved by a discharge system for filling and emptying of containers, particularly of barrel-like transport drums, comprising the features according to claim 1, whereby the container may be conductive or not.

Advantageous embodiments of the inventive discharge system are defined in the dependent claims.

The inventive discharge system comprises a grounding wire by means of which electric charges are derived from a liquid contained in the container to a grounding potential.

Due to the fact that the grounding wire is arranged on the discharge system, also inflammunable liquids in stable containers of large volume made of non-conductive material may be discharged without any risk of ignitions by electrostatic charges or strokes, respectively. With the discharge system also the filling of containers is possible.

According to a preferred embodiment, the inventive discharge system further comprises a plug head insertable into a container opening, a riser tube connected to the plug head and a removal connection element.

According to a further preferred embodiment, one or several components of the discharge system like the plug head, the riser tube, the removal connection element or a connection element for a fixed connection of the riser tube with the removal connection element are at least partially made of a conductive plastic filled with carbon, preferably of PE, PP, PVDF, ECTFE, PEEK of PTFE and are in conducive contact with the grounding wire. Preferably, the grounding wire is in conductive contact with or fixed to the removal connection element, respectively.

By the use of such materials, the discharge system is provided with a high ability to derive electrostatic charges. Furthermore, those materials can be used in common production processes for plastics, such as extrusion.

Thus, with the discharge system being mounted in a container a closed discharge circuit is formed between the liquid and its surface, respectively, via the riser tube, the plug head, the removal connection element and the grounding wire independent from the filling height in the container, via which electric charges on the surface of the liquid and also on the walls of the container may be discharged to a ground potential.

According to a further preferred embodiment the discharge system comprises a removal connection element which can be locked to the plug head by means of a stud coding system and can be connected in a sealing manner to the plug head by means of a connection element, preferably being formed as a coupling stopper. The stud coding system has coding studs and matching coding recesses. The coding studs are provided on a first securing part and the coding recesses are provided on a second securing part, it being the case that one of the securing parts is designed as an annular disc, which can separately be fitted loosely onto the modular removal connection element such that it cannot readily be removed again therefrom, i.e. such that it cannot slip off, and the other of the securing parts is integrated in the plug head.

Such a removal system ensures that the high degrees of purity of the special liquid chemicals mentioned remain intact even during removal operations. This is because, as a result of the special stud coding system, which according to the invention is provided as a separate component for the modular removal connection element, on the one hand, for reasons of safety and contamination, the risk of chemicals being mixed up is ruled out and, on the other hand, in terms of construction and dimensions, the actual removal connection element is identical for a vast range of different chemicals, the only difference being that the actual stud coding system has to be designed specifically for the respective application case. This makes it possible for such removal systems, which ensure the removal of specific chemicals with minimized contamination, nevertheless to be produced cost-effectively.

According to another preferred embodiment the plug head can be screwed into the container, and the coupling stopper, which engages through the annular disc by way of a threaded section, can be screwed into an internally threaded section which is sunken in the plug head. Thus, the removal connection element and the plug head can be reliably connected to one another in a sealing manner. The coupling stopper is arranged in a loosely displaceable manner on a cylindrical section of the removal connection element, and the annular disc is arranged displaceably and loosely on a cylindrical section above the externally threaded section of the coupling stopper, said externally threaded section engaging through the annular disc.

On its side which is directed towards the plug head, the removal connection element preferably has a flange which bears a first O-ring for sealing the removal connection element with respect to the plug head. Said O-ring is arranged on the flange such that in the braced state, i.e. in the state in which the coupling stopper has been screwed in a fixed and sealing manner into the sunken internally threaded section of the plug head, the connection element is connected to the plug head in a sealing manner.

According to a further preferred exemplary embodiment of the invention, the removal connection element, which in addition to removing the chemicals from the container also serves to ventilate the latter, is provided with a cylindrical tube section which projects into a cylindrical plug-head part which bears the riser tube. This cylindrical tube section of the removal connection element has a smaller diameter than the cylindrical part of the plug head and projects deeper into the cylindrical part of the plug head, when the removal connection element has been fitted, than a ventilation opening arranged in said cylindrical part. Said cylindrical tube section also has a sealing ring which, when the removal connection element has been fitted, is located beneath the ventilation opening in the cylindrical part of the plug head and has such an external diameter that, when the removal connection element has been inserted into the plug head, said seal, which is preferably likewise designed as an O-ring, effects a reliable sealing action in the interior of the cylindrical part. Said second O-ring is preferably borne in a groove of the cylindrical tube section and, inter alia, for the purpose of improving the sealing action when the removal connection element has been fitted and secured by means of the coupling stopper, is seated on a reduced-diameter section in the interior of the cylindrical part of the plug head, which is bounded by an annular shoulder beneath the ventilation opening. The second O-ring rests in a sealing manner in said section.

This creates a venting channel from the ventilation opening into the removal connection element. In order to route ventilation outwards, by way of the removal connection element, to a ventilation opening, the cylindrical section is extended into the removal connection element and, between its outer surface and the inner surface of the removal connection element, forms a space which leads into the ventilation connection line provided on said removal connection element. The discharge system according to the present invention thus permits simultaneous liquid removal and ventilation.

Further advantages, features and possible applications of the invention will be disclosed by means of an embodiment in combination with the attached drawings.

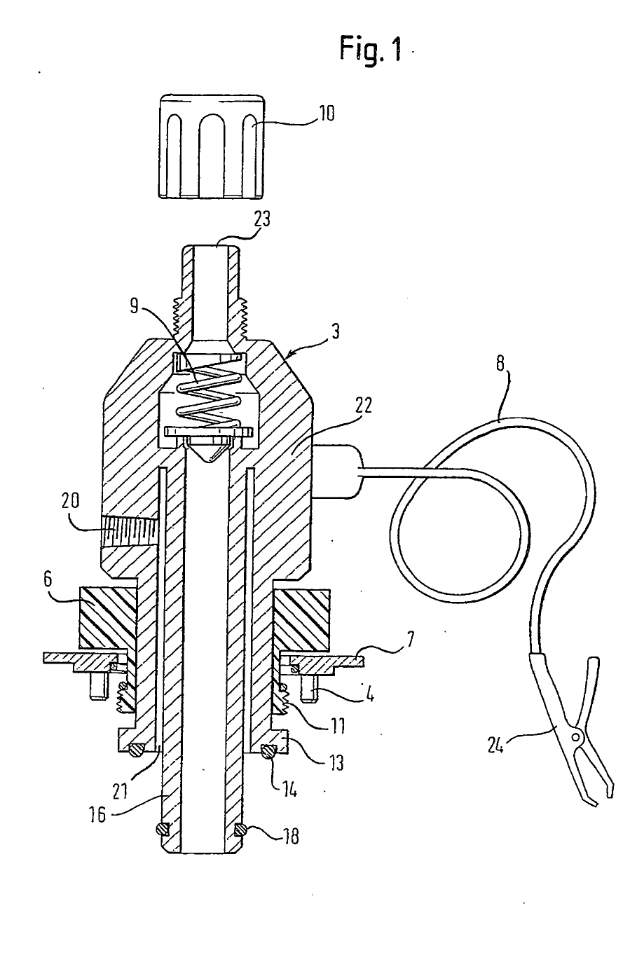

FIG. 1 shows a removable connection element of the inventive discharge system according to an embodiment;

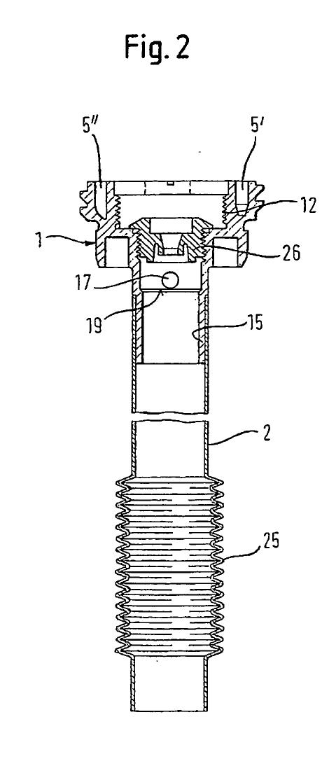

FIG. 2 shows a plug head of the inventive discharge system with the removable connection element being removed and with a threaded stopper being inserted;

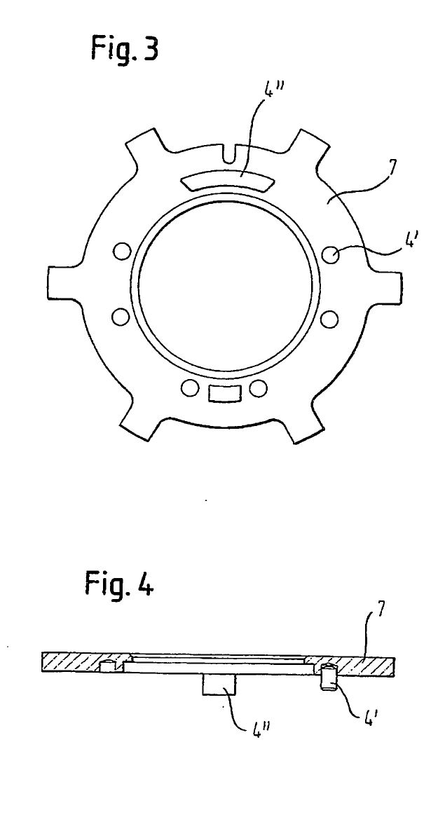

FIG. 3 shows the top view of a studded disk according to an embodiment of the invention; and

FIG. 4 shows a lateral sectional view of the studded disk according to FIG. 3.

FIG. 1 shows a removal connection element 3 of the inventive discharge system for filling and emptying of containers. The removal connection element 3 comprises a top cylindrical section 22 of a larger diameter being conically tapered in its top part towards a discharge piece 23. Above the discharge piece 23 a connection sleeve 10 is shown by means of which a tube or a hose for a discharge of a liquid from the container may be connected, preferably by screwing the connection sleeve 10 onto a thread which is provided on the discharge piece 23.

About in the middle of this cylindrical section 22 a grounding wire 8 is electrically connected to the removal connection element 3. At the end of the grounding wire 8 a clamp 24 is disposed for completion of the grounding by clamping of the clamp 24 to a grounding means (not shown). According to the practical requirements, it may be advantageous to dispose the grounding wire on another component such as a plug head 1 or a coupling stopper 6 of the discharge system. According to the circumstances, it may also be useful to fix the grounding wire to the grounding means with another connection means such as a screw instead of the clamp 24.

Furthermore, the removal connection element 3 has a cylindrical section, on which a coupling stopper 6 is arranged in a displaceable manner. This coupling stopper 6 has a threaded section 11, which matches the internally threaded section 12 which is sunken in the plug head 1, with the result that, for the purpose of fastening the removal connection element 3 in the plug head 1, the coupling stopper 6 can be screwed into the sunken internally threaded section 12. The head of the coupling stopper 6 is of flange-like design and supports an annular disc 7 with the inner end surface of a flange. The annular disc 7 is arranged loosely and displaceably on a thread-free section of the coupling stopper 6, the threaded section 11 engaging centrally through the annular disc 7. The annular disc 7 has coding studs 4, with the result that the annular disc 7 is designed as a studded disc. The coding studs 4 of the studded disc are arranged such that they are in a mirror-inverted and congruent arrangement on that surface of the annular disc 7 which is directed towards the outwardly oriented end surface of the plug head 1, and match the coding recesses 5 provided on the plug head 1 arranged in an container opening.

These coding recesses 5 are made as cylindrical recesses 5′ and circle-segment-shaped recesses 5″ at defined, i.e. coded, intervals on the circumference of the outwardly oriented end surface of the plug head 1. Accordingly, the coding studs 4 are designed as cylindrical studs 4′ and circular-ring-segment studs 4″ (FIGS. 3 and 4).

The coupling stopper 6, which bears the studded disc, is secured on the cylindrical part of the removal connection element 3 such that it cannot slip off, with the result that, once it has been fitted on said cylindrical part of the removal connection element 3, which is otherwise of identical design for different chemicals, said coupling stopper cannot readily be removed therefrom.

Furthermore, the removal connection element 3 comprises a check valve 9 inside the top cylindrical part 22, which may be used to block the flow of liquids into one direction, e.g. into the container in order to prevent the flow-back of a liquid into the container.

If the removal connection element 3 is to be connected with the plug head 1, in which case, in accordance with the stud coding system, only a coded arrangement of cylindrical and circular-ring-segment studs matches the correspondingly formed recesses, then the first step is for the removal connection element to be fitted, by way of its cylindrical tube section 16, into the plug head 1, as far as the region of the cylindrical part 15 of said plug head 1.

Thereafter, the grounding wire 8 is clamped to the grounding means by means of the clamp 24. Therewith, a connection for a derivation of charges is ensured between the electric charges being present in the container or on the liquid, respectively, via the riser tube 2, the plug head 1, the removal connection element 3 and the grounding wire 8 such that no danger of ignitions by electrostatic discharges lasts.

Thereafter, the studded disc 7 is rotated such that its coding studs 4 match the corresponding coding recesses 5 and these studs are inserted into these coding recesses until the studded disc 7 rests on the outer end surface of the plug head 1. After this, the coupling stopper 6, which engages through the central region of the studded disc 7 by way of its threaded section 11, is screwed into the sunken internally threaded section 12 of the plug head 1 until the removal connection element 3 is fixedly connected to the plug head 1. In order to prevent the coupling stopper 6 with the studded disc 7 from being removed from the cylindrical part of the removal connection element, the latter has a stop flange 13 at the end of the cylindrical section.

Provided on the end side of said stop flange 13 is a first O-ring 14, which is arranged in a groove and, in the fitted state, provides for sealing of the removal connection element 3 in the plug head 1. In this case, said first O-ring 14 rests on a shoulder which is arranged in the interior of the plug head 1 at the end of the sunken internally threaded section 12.

The plug head 1 has a cylindrical part 15 which is oriented in the direction of the container interior. A ventilation opening 17 is provided in said cylindrical part. The internal diameter of said cylindrical part 15 of the plug head 1 is greater than the external diameter of the cylindrical tube section 16 of the removal connection element 3, there being arranged beneath the ventilation opening 17 an annular shoulder 19, from which the internal diameter of the cylindrical part 15 of the plug head 1 decreases. Even this reduced-diameter section beneath the annular shoulder 19 in the cylindrical part 15 of the plug head 1 is greater, in terms of its internal diameter, than the external diameter of the cylindrical tube section 16 of the removal connection element 3.

Provided at one point of the cylindrical tube section 16 of the removal connection element 3, which, in the fitted state of the removal connection element 3, is located in the cylindrical part 15 of the plug head 1 beneath the ventilation opening 17, is a second O-ring 18, which is provided in a groove and seals a space, for ventilation and venting purposes, in the downward direction into the riser tube 2, said space being provided between the inner surface of the cylindrical part 15 of the plug head and the outer surface of the cylindrical tube section 16 of the removal connection element 3.

Said cylindrical tube section 16 of the removal connection element 3 is routed upwards, far into the interior of the removal connection element 3, in the form of a cylindrical annular gap 21 according to FIG. 1, to be precise into a region of the removal connection element 3 which is thickened and at which venting valves or lines, via which the corresponding ventilation takes place, can be screwed into a connection stub 20.

A riser tube 2 is pushed rigidly onto the cylindrical part 15 of the plug head 1, said cylindrical part extending into the container, with the result that the riser tube is retained by said cylindrical part 15. Arranged at the bottom end of the riser tube 2 is an opening funnel (not shown) which, when the plug head 1 has been inserted, is seated on the container base. On its end surface which is directed towards the container base, the opening funnel has circumferentially spaced-apart webs (not shown) which ensure that a sufficient flow cross-section is provided between the container base and the webs when the opening funnel of the riser tube 2 has been seated on the container base.

In order to ensure a sufficient discharging capability of the discharge system, all or single components of the discharge system may be made of highly conductive plastics. For example, it can be omitted to produce the coupling stopper 6 of highly conductive plastics without risking a good discharging capability of the total system, as the electric discharging via the discharge system is ensured by the contact between the remaining components. Furthermore, it is conceivable to produce single components only partially of highly conductive material or to attach corresponding inserts made of highly conductive material e.g. having the shape of stripes to single or all components. Such embodiments, however, always have to ensure that a sufficient and conductive connection consists between the electric charges in the container, i.e. the liquid and the grounding wire 8 or the grounding potential, respectively, in the mounted state of the discharge system.

Preferably, PE, PP, PVDF, ECTFE, PEEK or PTFE is used as the highly conductive plastic material.

Preferably, those materials are plastics filled with carbon up to 10%. They comprises a surface resistivity of more than 10⁷ Ω, such that a sufficient electrical discharging capability consists. Also, a mixture of materials for the components is conceivable.

A section which is designed as a folding bellows 25 is located in the region between the top part of the riser tube 2, said top part being seated on the cylindrical part of the plug head 1, and the opening funnel of said riser tube. This folding bellows can compensate for several centimeters in the longitudinal direction in order to cover different distances between a base or a wall of a container and the plug head 1, which is located opposite and has been screwed into a container opening. This also makes it possible to use one and the same discharge system for different container dimensions and types of container.

FIG. 2 illustrates a plug head 1, which bears the riser tube 2, it being the case, in this illustration, that the removal connection element 3 has not been inserted. A threaded stopper 26 may be screwed in a sealing manner into the plug head 1, into a threaded section of the plug head, in the removed state of the removal connection element 3.

The containers either may be provided with a conventional closure or may have already been equipped with such a plug head 1 which, in the delivery state, bears the threaded stopper 22 for closure purposes. This ensures that just one coding stud arrangement, which matches the spacings and forms predetermined by the coding recesses 5 in the plug head 1, and thus a specific removal connection element 3, fits. Consequently, the predetermined stud coding system rules out any mix-up of chemicals.

The point on the cylindrical part 15 at which the ventilation opening 17 is arranged can also be seen from FIG. 2. Arranged beneath the ventilation opening 17 is the annular shoulder 19, from the bottom of which, in the direction of the riser tube 2, the reduced-diameter section of the cylindrical part 15 of the plug head 1 is provided.

The annular disc 7, which is designed as a studded disc, is illustrated in FIG. 3. Cylindrical studs 4′ and circular-ring-segment studs 4″ are spaced apart circumferentially on that end side of the annular disc which, in the fitted state, is directed towards the coding recesses 5 in the plug head 1. A variation in spacings and in the form of the studs, which may also be of, for example, rectangular or triangular cross-section, can provide any number of stud coding systems, which ensures that it is only possible for the coding stud arrangements and forms which match predetermined recesses 5 in the plug head 1 to be used and thus the associated removal connection element to be connected.

In order that, when the removal connection element 3 is fitted in the plug head 1, the correct positioning of the studded disc 7 in relation to the recesses located in the plug head 1 can be identified and implemented quickly, the studded disc 7 has a marking slit arranged on the circumference. The outwardly projecting, tooth-like extensions serve for bringing the studded disc into the necessary coding position.

FIG. 4 illustrates a lateral sectional view of the studded disc according to FIG. 3. In this illustration, a cylindrical coding stud 4′ and a circular-ring-segment coding stud 4″ have been inserted into the disc or provided thereon. Said coding studs may either be attached using conventional, known adhesive-bonding methods or be inserted into appropriately prepared openings and likewise fastened to the studded disc by adhesive bonding.

The discharge system according to the invention, thus rules out an ignition or explosion by electrostatic chargings or strokes, respectively, particularly during the removal of a liquid or a chemical, where this risk is the biggest. Furthermore, the discharge system according to the invention in conjunction with the stud coding system, thus rules out any mix-up of chemicals and, consequently, any contamination of high-purity chemicals. Moreover, the discharge system according to the invention permits simultaneous liquid removal and ventilation of the container, in order that the liquid can be removed without difficulty. Moreover, the discharge system according to the invention is constructed such that the coupling stopper described means that liquid lines and ventilation lines do not have to be separated when the removal connection element is connected to the plug head or removed therefrom. Since the plug head is adapted to commercially available drum threads, in particular, it is also possible for the discharge system according to the invention to be used in commercially available containers, in particular drums. Furthermore, the design according to the invention means that the discharge system according to the invention satisfies the requirements for the existing licensing of hazardous substances. The inventive configuration of the discharge system in conjunction with the riser tube ensures a high throughflow rate, of at least 20 l/min, of liquid which is to be removed from the container.

1. Discharge system for filling and emptying containers, in particular drum-like transporting containers, in particular for the uptake of inflammable liquids, wherein the discharge system comprises a grounding wire (8) by means of which electric charges are discharged from a liquid being up-taken in the container to a grounding potential.

2. Discharge system according to claim 1, further comprising a plug head (1) being insertable into a container opening, a riser tube (2) being connected to the plug head (1) and a removal connection element (3)

3. Discharge system according to claim 1 or 2, wherein at least one of said plug head (1), said riser tube (2) and said removal connection element (3) and a connection element (6) for connecting said riser tube (2) with said removal connection element (3) is at least partially made of conductive plastic material filled with carbon, preferably of PE, PP, PVDF, ECTFE, PEEK or PTFE, and is in conductive contact with the grounding wire (8).

4. Discharge system according to any of the preceding claims, wherein said grounding wire (8) is in conductive contact with said removal connection element (3).

5. Discharge system according to any of the preceding claims, wherein said removal connection element (3) can be locked to said plug head (1) by means of a stud coding system (4, 5) and can be connected thereon in a sealing manner by a connecting element preferably formed as a coupling stopper (6), and wherein said stud coding system having coding studs (4) and matching coding recesses (5), said coding studs (4) are fixed on a first securing part (4, 7) and said coding recesses (5) are fixed on a second securing part (1, 5), wherein one of the securing parts is designed as an annular disc (7), which is separately fitted loosely, protected from being stripped off, onto said modular removal connection element (3), and the other one of said securing parts is integrated in said plug head (1).

6. Discharge system according to any of the preceding claims, wherein said plug head (1) can be screwed into the container, and said coupling stopper (6), which engages through said annular disc (7) by way of a threaded section (11), can be screwed into an internally threaded section (12) which is sunken in said plug head (1).

7. Discharge system according to any of the preceding claims, wherein said removal connection element (3) has a flange (13) on its side, which is directed towards said plug head (1), which bears a first O-ring (14) for sealing said removal connection element (3) with respect to said plug head (1).

8. Discharge system according to any of the preceding claims, wherein said removal connection element (3) has a cylindrical tube section (16) for ventilation purposes which projects into a cylindrical part (15) of said plug head (1), said cylindrical part bearing said riser tube (2), has a smaller diameter than said cylindrical part (15) of said plug head (1), projects deeper into said cylindrical part (15) of said plug head (1), when said removal connection element (3) is installed, than a ventilation opening (17) arranged in said cylindrical part, and is sealed with respect to said cylindrical part (15) of said plug head (1) by means of a seal (18) beneath the ventilation opening (17).

9. Discharge system according to any of the preceding claims, wherein said seal (18) has a second O-ring which is borne in a groove of said cylindrical tube section (16) and, when said removal connection element (3) is installed, rests in a sealing manner in a reduced-diameter region of said cylindrical part (15) of said plug head (1).

10. Discharge system according to any of the preceding claims, wherein said cylindrical tube section (16) is extended into said removal connection element (3) and forms a space (21) between its outer surface and the inner surface of said removal connection element (3), which leads to a ventilation connection line (20) fastened on said removal connection element.
